(19) United States
(12) Patent Application Publication
(10) Pub. No.: US 2022/0244679 A1
(43) Pub. Date: Aug. 4, 2022

(54) HOLOGRAPHIC OPTICAL SYSTEM

(71) Applicant: TruLife Optics Ltd., London (GB)

(72) Inventors: Andrii VOLKOV, London (GB); Ben SHERLIKER, London (GB)

(73) Assignee: TruLife Optics Ltd., London (GB)

(21) Appl. No.: 17/588,846

(22) Filed: Jan. 31, 2022

(30) Foreign Application Priority Data
Feb. 3, 2021 (GB) 2101488.1

(51) Int. Cl. G03H 1/04; G02B 5/32

(52) U.S. Cl. CPC G03H 1/0402; G03H 2222/12; G03H 2001/0439; G02B 5/32

(57) ABSTRACT

A holographic optical system is provided, including: a light source; a collimator, arranged to receive from the light source and having an output surface configured to provide collimated light, optical properties of the collimator generating aberrations in the collimated light; and an aberration-compensating holographic optical element having a planar diffractive surface arranged to receive collimated light from the output surface, the planar diffractive surface having optical properties such that output light from the planar diffractive surface is compensated for the aberrations generated by the collimator.

### CROSS REFERENCE TO RELATED APPLICATION

This application claims the benefit under 35 U.S.C. § 119(a) of United Kingdom Application No. GB2101488.1 filed Feb. 3, 2021, the contents of which are incorporated by reference herein in their entirety.

### BACKGROUND OF THE DISCLOSURE

### 1. Field of the Disclosure

The disclosure concerns a holographic optical system that may form part of a gunsight.

### 2. Description of the Related Art

Gunsights may be designed to provide a virtual image of a reticle overlaid on the real world, at a far focal plane (close to infinity). The reticle should have low parallax error (that is, the position of the reticle does not shift relative to the real world at a set focal plane). The reticle should be viewable over a relatively large eyebox, such that the physical size (aperture) of the reticle should be in the order of 25.4 mm (1 inch) to allow for easy viewing of the reticle. A reticle can be provided as either a dot (a magnified point source) or an extended shape created with a mask, for example crosshairs.

Existing gunsight designs are typically of two generic designs: a red dot (or reflex) sight which uses a partially transparent, partially reflective optical element to collimate an off-axis point source (typically a red LED with a pinhole mask) to provide an image of the source (pinhole) at infinity; or a holographic gunsight, whereby an image of the reticle (for instance, crosshairs, red dot or similar) is recorded into a holographic optical element. The former is typically limited to red dots due to the aberrations inherent in off-axis designs becoming more challenging to correct for with extended sources (that is, the reticle is no longer a point source).

To achieve a low parallax error, the optical system desirably provides an unaberrated image of a magnified, collimated reticle to the user. To allow the user to see through the optical system, reduce stray light and reduce bulk, the system should have high transparency and preferably use a light path that is off-axis (the optical path for external light through the optical system being considered on-axis). An off-axis point source can be collimated by an off-axis, partially transparent parabolic mirror.

A holographic gunsight can provide an unaberrated reticle across a large aperture with a compact form factor. A known problem with holographic gunsights is chromatic dispersion, whereby the angular position of the reticle may change as the wavelength of the replay source changes. This is sometimes termed drift, or parallax error. A laser is often used as the replay source, but a wavelength of the laser may change as the current passing through it changes, or as the ambient temperature changes. Alternatively, a broadband source such as a Light Emitting Diode (LED) can be used with an off-axis hologram, as LEDs are typically cheaper and draw less electrical power than laser diodes. However, this may cause chromatic blur, whereby the reticle image is blurred. One option to mitigate this problem is to stabilise the laser wavelength, but this requires expensive and bulky electronics and/or lasers.

Alternatively, chromatic dispersion compensation can be effected using multiple linear diffractive gratings. Referring to FIG. 1, there is shown a schematic diagram of a first known optical system for providing a red dot virtual image to a user, similar to that described in US-2020/0011638. This comprises: a point light source 101; a collimating parabolic mirror 102; and a first linear diffractive grating 103; a second linear diffractive grating 104; and a beamsplitter 105. Light from outside the optical system (not shown) passes through the beamsplitter to the user 106, thereby defining an axis. The point light source 101 and collimating parabolic mirror 102 are both off-axis. Light from the point light source 101 is collimated by the parabolic mirror 102 and directed towards the first linear diffractive grating 103. The first linear diffractive grating 103 and the second linear diffractive grating 104 are each a Holographic Optical Element (HOE) or Diffractive Optical Element (DOE) (linear means there is no optical power in the hologram, that is the pitch or line spacing is constant). Together, they provide chromatic dispersion compensation, such that the red dot virtual image is provided to the user 106 with achromatic properties. A reticle can be recorded in a second linear diffractive grating 104 or the collimated point source itself can be used.

A parabolic off-axis mirror provides perfect collimation for a small point source. However, a parabolic mirror is expensive to make compared to a spherical mirror. In contrast, a typical off-axis spherical mirror will have inherent spherical aberrations and, when it is used in an off-axis geometry, it will also produce coma aberrations. It therefore cannot be used in place of a parabolic mirror without multiple corrective elements that only partially correct for dispersion, such that some parallax error remains.

Referring to FIG. 2, there is shown a schematic diagram of a second known optical system for providing a red dot virtual image to a user, similar to that described in U.S. Pat. No. 6,490,060 B1. This comprises: a point light source 201; a planar mirror 202; a spherical Mangin mirror 203 (having a reflective rear surface and a refractive front surface); a reflective linear diffraction grating 204; and a transmissive HOE 205. The spherical Mangin mirror 203 collimates the light, reducing spherical aberrations in comparison with a true spherical mirror. The linear diffraction grating 204 provides chromatic dispersion compensation. The HOE 205 provides a holographic reticle image 206 to a user eye (for example, crosshairs). The spherical Mangin mirror 203 is an expensive element and still produces coma aberrations in an off-axis geometry.

Referring to FIG. 3, there is shown a schematic diagram of a third known optical system for providing a red dot virtual image to a user, similar to that described in RU152500U1. This comprises: a point light source 301; a diffraction grating on a curved surface 302; and a transmissive HOE 303, which provides a holographic reticle image 304. The diffraction grating on a physically curved surface 302 acts as a collimating element, but this is expensive to make.

Existing holographic gunsights therefore use expensive and/or bulky components to mitigate aberrations and chromatic dispersion. It is desirable to provide a holographic reticle for a gunsight without these issues.

### SUMMARY

Against this background, there is provided an optical system, particularly a holographic optical system and a method for manufacturing a holographic optical element for use in a holographic reticle device. A simple inexpensive spherical mirror or equivalent collimating lens is used (instead of a parabolic mirror) as the collimating element and an extra holographic optical element (HOE) is introduced into the optical system, which can correct for geometrical aberrations introduced by an off-axis reflective collimating system (typically spherical and coma), for instance due to a tilt between the collimator and the downstream HOE. This HOE thus has an extra aberration correction function. This provides a well collimated beam with inexpensive off the shelf elements.

As a result, a compact holographic gunsight may be provided with minimal parallax error that compensates for spherical and/or coma aberrations in a cost effective and power efficient manner, preferably using an LED as a replay source. This fills a gap in the market for such a device.

The holographic optical system is optimised to provide a virtual image at a far distance with aberration correction and preferably, dispersion compensation. These factors allow for a holographic gunsight to be produced which is cost-effective to manufacture, compact, and has low power draw (long battery life). A highly transparent, high quality view of the real world may be provided using the gunsight with low stray light and a large aperture (eye-box). The unaberrated virtual reticle image may be overlaid on the real world with zero (or low) parallax error across the eyebox at the desired focal plane (typically 20 m to 300 m for a gunsight). The distance between the replay light source and the collimator is advantageously less than the focal length of the collimator. The compact, low height design may maximise a view of the real world for a user.

A beamsplitter or other optical combining element may combine the light from the one or more HOEs and/or other diffractive elements with external light and direct the combined light along an axis. The collimator and/or the light source are advantageously off-axis.

The (replay) light source may be a point light source (for instance, a laser or LED with a pinhole mask), a (broadband) LED, an arrangement with a light source and a reticle mask, a self-emissive display or a display projected onto a transmissive diffuser. The light source may be formed from combinations or sub-combinations of these features.

The system is advantageously also designed to compensate for chromatic dispersion introduced by the diffractive nature of a HOE, by use of a further diffractive element or HOE. The aberration-compensating holographic optical element and the diffractive element or HOE are preferably parallel. The system allows for a broad band point source (an LED with a pinhole mask) to be used, providing a low parallax error, unaberrated, magnified image of the pinhole to appear overlaid on the real world at infinity (or close thereto). The ability to use an LED rather than a laser with a holographic gun-sight may provide a speckle-free image of any colour which is desirable. A reticle image may be holographically recorded into the further diffractive element or HOE, or another HOE.

The present disclosure may also thereby provide an achromatic optical system that is largely immune to chromatic dispersion and hence reticle parallax drift. As noted above, a cheap, low power LED can be used rather than an expensive, higher power laser, and there is no need for electronics to control the wavelength of the laser (which changes as a function of laser current and ambient temperature). This may increase the battery lifetime. It may also become simpler to control the brightness of the reticle by simply adjusting the current to the light source (LED or laser). In known designs, as the current to the laser changes, the wavelength changes. This may cause reticle drift, which is often mitigated by applying constant current and modulating the laser on and off rapidly or using a separate brightness control system (for instance, an adjustable polariser), which adds to cost and complexity. It also becomes simpler to align the system and cover the eyebox as an LED emits a spherical beam with a high divergence whereas a laser diode typically emits an elliptical beam with a lower divergence.

In some embodiments, each HOE or diffractive element is reflective (and may be black-backed). In embodiments, each HOE may provide coupling into or out from a waveguide or lightguide. Light may pass through the waveguide to the incoupling HOE and/or from the outcoupling diffractive element to downstream optics (or the viewer).

Manufacturing of a HOE for use in such a holographic optical system (particularly for aberration compensation) may be performed by splitting a coherent beam of laser light into a reference beam and an object beam and directing each to opposite sides of a planar photosensitive material. The object beam is directed via a collimator that may be tilted with respect to the plane of the photosensitive material. The collimator may be the same as used during replay or may simply have the same focal length.

Combinations of aspects or features from aspects may also be considered, where such combinations are feasible.

### BRIEF DESCRIPTION OF THE DRAWINGS

The disclosure may be put into practice in a number of ways and preferred embodiments will now be described by way of example only and with reference to the accompanying drawings, in which:

FIG. 1 shows a schematic diagram of a first known optical system for providing a red dot virtual image to a user.

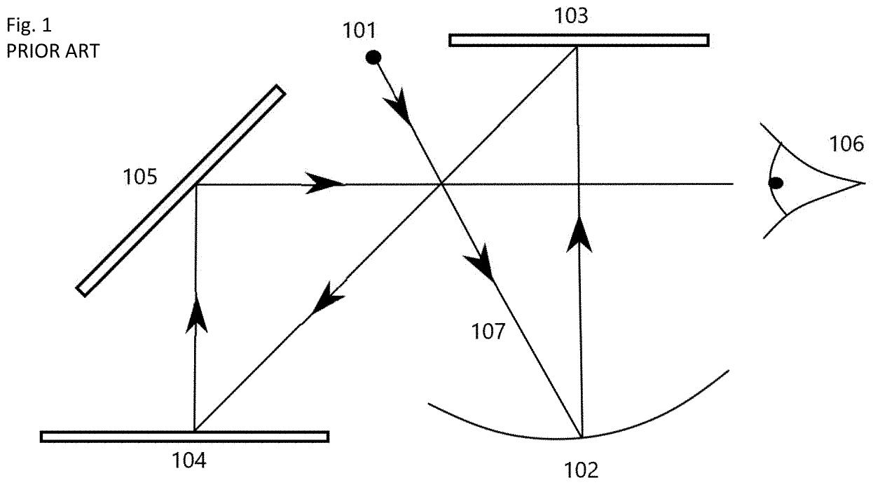

FIG. 2 shows a schematic diagram of a second known optical system for providing a red dot virtual image to a user.

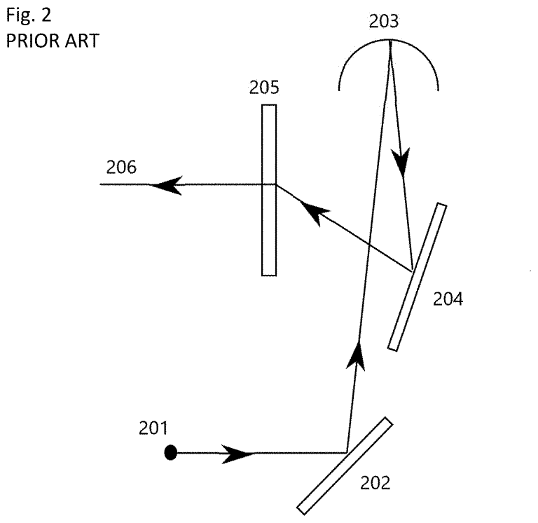

FIG. 3 shows a schematic diagram of a third known optical system for providing a red dot virtual image to a user.

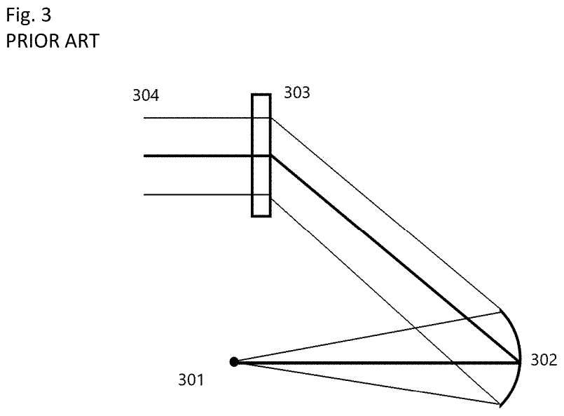

FIG. 4 depicts a schematic diagram of an optical system for providing a red dot virtual image to a user in accordance with a first embodiment of the disclosure.

FIG. 5 depicts a schematic diagram of an optical system for providing a red dot virtual image to a user in accordance with a second embodiment of the disclosure;

FIG. 6 illustrates a schematic ray tracing model of an optical system in accordance with the embodiment of FIG. 4.

FIG. 7 shows a first portion of lens data from ray tracing software, including distances and angles for the embodiment of FIG. 6.

FIG. 8 shows a second portion of lens data from ray tracing software, particularly for a Zernike phase surface in the embodiment of FIG. 6.

FIG. 9 schematically shows an arrangement for fabricating a holographic optical element in accordance with the disclosure.

### DETAILED DESCRIPTION

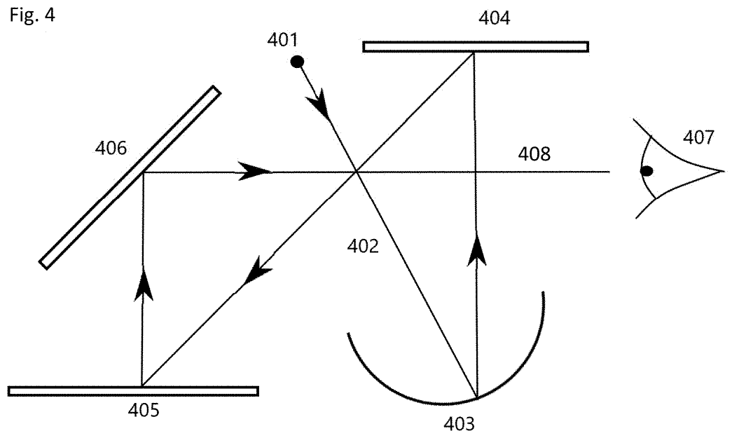

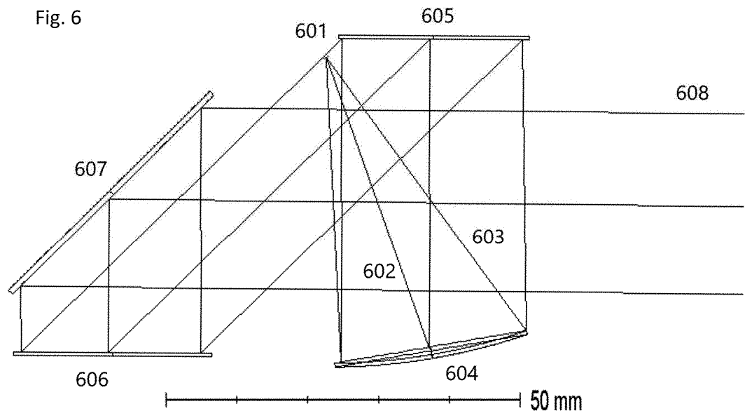

Referring first to FIG. 4, there is depicted a schematic diagram of an optical system for providing a red dot virtual image to a user in accordance with a first embodiment of the disclosure. This is a nominal design, which has also been modelled in ray tracing software (as discussed with reference to FIG. 6 below) and fabricated experimentally. This comprises: a light source 401; a spherical mirror 403; a first holographic optical element (HOE) 404; a second HOE 405; and a beamsplitter 406. Reticle light is provided to a user eye 407. An axis of light 408 entering the user eye 407, comprising the reticle light and light passing through the beamsplitter 406 from outside the optical system is shown (such that the axis 408 is in line with the eye 407 of the user).

Light source 401 is a point source of light, for instance, a laser diode, VCSEL (Vertical Cavity Surface Emitting Laser) or a LED with a masking pinhole (not shown, typically of diameter approximately 50 μm). Emitted light chief (or central) ray 402 is incident on the spherical mirror 403 (for clarity, only the chief ray 402 is shown in this drawing). The distance of the chief ray 402 to the centre of the spherical mirror 403 is slightly less than the focal length of the spherical mirror 403, for example 25 mm.

The distance travelled by chief ray 402 between the light source 401 and the spherical mirror 403 can be calculated from the mirror equation. This distance is designed to set the virtual image of the reticle light at a far distance, for instance 200 m. If the distance was precisely the focal length of the spherical mirror 403, the image would be set at infinity. The magnification of the object (pinhole) is set by the distance travelled by chief ray 402 between the light source 401 and the spherical mirror 403 and is again given by the mirror equation.

The angular size of the magnified image presented to the user is determined by the magnification and the pinhole diameter. Typical values would be a pinhole of 50 micron diameter providing an image of 3 MOA (minutes of arc). As the angular size of the image increases, the aberrations will increase. Thus, the reticle should cover a relatively small field of view (FOV), typically less than 2 degrees.

The light is reflected via the spherical mirror 403 onto the first HOE 404, with the angle between a normal to a centre of the reflective surface of the spherical mirror 403 and a normal to the first HOE 404 being non-zero (that is, the normals are not parallel). Typically, this angle is at least or greater than 5 degrees and/or no more or less than 20 degrees and in the preferred embodiment, the angle is 12 degrees. This introduces coma aberrations due to the off-axis angle, and spherical aberrations from the spherical mirror. The spherical mirror 403 allows the optical path to be folded and the system to remain compact.

The first HOE 404 has special properties. It comprises a planar diffractive element that has a suitable phase function (for instance, a Zernike surface function or binary phase function) to correct for the aberrations generated by the off-axis spherical mirror, and diffract a well-collimated beam towards the second HOE 405. The first HOE 404 is fabricated holographically, as discussed below. It is beneficially manufactured to correct (or compensate for) the aberrations introduced by the spherical mirror exactly.

The second HOE 405 has a planar linear diffractive grating (a physical diffraction grating or a holographically created linear grating), which diffracts the incident beam. The angles of first HOE 404 and second HOE 405 and their grating pitches (spacing) are determined to provide zero chromatic dispersion; that is, the two elements cancel the chromatic dispersion inherent with a single diffractive element. Ideally, the first HOE 404 and the second HOE 405 are parallel to each other. It is more straightforward to compensate for the chromatic dispersion across the whole wavelength range of the light source 401 if the first HOE 404 and the second HOE 405 are parallel. As the two elements deviate from being parallel, the chromatic dispersion worsens and the image blur increases and the aberration compensation may only be perfect for a limited part of the wavelength range. However, being parallel is not strictly critical and slightly off parallel elements will just give a slightly worse result.

Beamsplitter 406 is a planar, on-axis and partially transparent, which provides the virtual magnified image of the reticle dot (pinhole) to the user eye 407 overlaid on the real world. The beamsplitter 406 can be a plain piece of glass, a partially silvered beamsplitter, or a dichroic coated beamsplitter. Preferably, as is known to those skilled in the art, the beamsplitter has a high reflectivity from a first (front) surface and a (very) low reflectivity from a second (opposite, that is back) surface, in particular such that only one reflection is visible to the user, removing unwanted double images.

The diffraction angles of the first HOE 404 and the second HOE 405 are designed such that the unwanted specular reflections are not visible to the eye. In addition, the first HOE 404 and the second HOE 405 are painted black on the back (or otherwise back-blacked) to absorb stray light. All elements are enclosed in a black housing to remove stray images due to ambient light. As there is no stray light passing to the outside world, the optical system (and therefore, the user) will not be noticed by a target in the real world.

The diameter of the spherical mirror is typically 1 inch (25.4 mm) and the size of the other elements (first HOE 404, second HOE 405 and beamsplitter 406) are typically 1 inch (25.4 mm) square. This provides a 1 inch (25.4 mm) diameter eyebox to the user, using a device with a compact 2 inch (50.8 mm) cubed volume (approximately).

Residual spherical and coma wavelength dependent aberrations may still be present and residual spherochromatism and comachromatism may therefore be in the reticle light. When using a broadband source (for example, an LED) there may be some colour shift across the image due to the diffractive nature of the system (that is, the image will change colour slightly when viewed top to bottom). A broadband source may be considered a source with at least (or greater than) 5 nm full width at half maximum (FWHM). However, provided the image is small (no more than 2 degrees FOV) and the eyebox is moderate (no more 2 inches or 50.4 mm), these aberrations and colour shift will not be noticeable to the eye with the typical laser wavelength drift or typical LED bandwidth.

In general terms, there may be considered a holographic optical system, comprising: a (replay) light source; a collimator, arranged to receive from the light source and having an output surface configured to provide collimated light; and an aberration-compensating holographic optical element having a planar diffractive surface arranged to receive collimated light from the output surface. A normal to the planar diffractive surface is tilted with respect to a normal to a centre of the output surface of the collimator.

Optical properties of the collimator generate aberrations in the collimated light. For example, spherical and/or coma aberrations in the collimated light. Typically, the collimator is a spherical mirror and the output surface is a concave surface. The planar diffractive surface has compensating optical properties, that is, such that output light from the planar diffractive surface is compensated for the aberrations generated by the collimator (for instance, spherical and/or coma aberrations). For example, the planar diffractive surface may comprise a Zernike standard phase surface. The holographic optical system advantageously provides a holographic reticle.

In preferred embodiments, the holographic optical system forms part of a gunsight (for instance, to provide a holographic reticle in the gunsight). Typically, a distance between the light source and (a centre of the output surface of the) the collimator is less than a focal length of the collimator. This may set the virtual image in the output light from the planar diffractive surface at a far, finite distance. A method of operating a holographic optical system (or gunsight comprising such a holographic optical system) may also be considered, for example comprising steps of directing light from the light source to the collimator of the holographic optical system, in particular to cause replay of the hologram (recorded in the holographic optical element and/or one or more other holographic optical elements).

A reticle image is beneficially holographically recorded into a reticle-generating holographic optical element. This may be the aberration-compensating holographic optical element, but more typically, is another downstream holographic optical element.

An optical combining element, for example a beamsplitter, may be arranged to receive the output light or the output light with further processing, to receive light from outside the optical system, to combine the received light and to direct the combined light along an axis. Then, the collimator and/or the light source are preferably off-axis. This may further provide a compact device, but result in the need to correct aberrations introduced by the off-axis collimator.

In the preferred embodiment, there is further provided: a chromatic-compensating optical element having a diffractive surface (for example, a linear diffractive surface), which is typically a holographic optical element. The planar diffractive surface of the aberration-compensating holographic optical element and the diffractive surface or the chromatic-compensating optical element are advantageously together configured to provide zero chromatic dispersion and they are preferably parallel. In the preferred embodiment, the chromatic-compensating optical element is the reticle-generating holographic optical element discussed above.

The aberration-compensating holographic optical element and the chromatic-compensating optical element are preferably reflective and optionally black-backed.

The light source advantageously comprises one or more of: a point light source (for example using a pinhole mask); a LED (particularly a broadband LED, for example emitting wavelengths of multiple colours); a laser diode or vertical-cavity surface-emitting laser (VCSEL) device; an arrangement comprising a light source and a mask (for example with a reticle formed on the mask); a self-emissive display; and a display projected onto a transmissive diffuser. A brightness controller may be configured to adjust an electrical current applied to the light source, in order to control the brightness of the output light. This may be particularly useful with a LED light source.

The preferred embodiments are advantageous, as they allow for the most compact form factor (for instance, as the elements may be largely conformal with the gunsight housing), with the fewest unwanted reflections (double images) from optical surfaces, minimal stray light and any specular reflections are removed from line of sight of a viewer.

Further generalised features will be discussed below. Manufacture or fabrication of such an optical system will first be considered.

A reflection volume hologram is fabricated with a coherent beam of laser light split into two beams and incident on a photosensitive material (for instance, silver halide or photopolymer). Thick, (volume) reflection holograms are preferred over thin holograms (or lithographically created diffraction gratings) due to their higher efficiency and reduced stray light due to minimising unwanted orders.

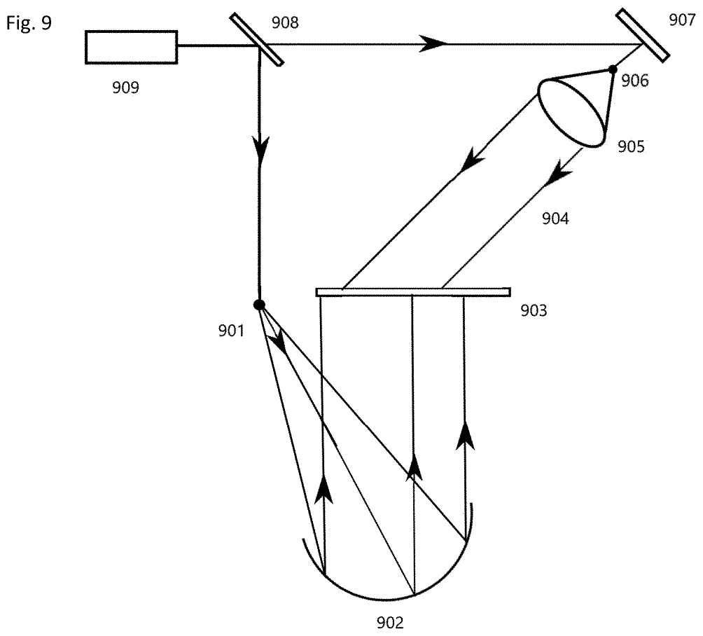

To fabricate the first HOE 404, an arrangement that similar to that shown in FIG. 4 may be used. Referring to FIG. 9, there is schematically shown an arrangement for fabricating a holographic optical element in accordance with the disclosure. This comprises: a coherent infrared laser (ideally of 850 nm wavelength); a beamsplitter 908; a mirror 907; a first pinhole mask to form a first point light source 901; a second pinhole mask to form a second point light source 906; a collimating lens 905 to form a collimated light beam 904; a spherical mirror 902; and a photosensitive material 903. A coherent laser light source from the laser 909 is split into two by the beamsplitter 908. A first portion of the split light is directed to the first pinhole mask for form the first point light source 901 (object beam), which is directed onto one side of the photosensitive material 903 via the spherical mirror 902. The collimated beam (reference beam) 904 is generated by the pinhole mask to form second point light source 906 that diverges the laser onto the collimating lens 905. The reference beam 904 is then directed onto the other side of the photosensitive material 903 to record a hologram in reflection geometry. The spherical mirror 902 need not be the exact same mirror as to be used during replay, as long as it has the same focal length as the spherical mirror 403 used in replay.

The angle of the reference beam 904 to the surface normal of the photosensitive material 903 (which will thereby fabricate HOE 404) is preferably around 45 degrees. This provides for a suitable eyebox size of approximately 25 mm to 35 mm (as shown with reference to FIG. 4). The diffraction angle is desirably large enough (for example, at least or greater than 30 degrees) such that any specular reflections from the surface are separated from the diffracted light and hence not in the line of sight of the user. If the diffraction angle is too large (typically at least or greater than 60 degrees), then the eyebox size may be reduced. In addition, as the off axis diffraction angle increases, the chromatic dispersion is increased and compensation for it can be more difficult.

The second HOE 405 can be fabricated as a reflection hologram using two collimated beams as is known to those skilled in the art. Ideally, the first HOE 404 and the second HOE 405 use the same angle of reference beam, so the grating spacing is identical (lines/mm) at the centre of both elements. The second HOE 405 can also have a reticle image holographically recorded into it to provide the reticle (for instance, a crosshairs) rather than a red dot. However, this is more expensive to fabricate than a linear grating.

The first HOE 404 and the second HOE 405 are designed so that together they correct for chromatic dispersion. This may be, for example, as discussed with reference to US-2020/0011638 and the same technique may be employed here. With a single diffraction grating (the first HOE 404), each wavelength is diffracted a different angle. Therefore, the light spreads out and may blur the image. Instead, another equal and opposite diffraction grating (the second HOE 406) is used to diffract the light back to keep the original angles. This may compensate for chromatic dispersion caused by the first diffraction grating and is similar to a waveguide with a symmetrical incoupler and outcoupler. The resultant zero chromatic dispersion (or achromatic property) is only strictly true at the centre of the second HOE 405, as the grating structure within the aberration compensating element (the first HOE 404) will not be strictly linear and symmetrical to the second diffractive element (second HOE 405). However, the property will largely apply over a small field of view, which should be true for most (if not all) practical cases.

In another generalised aspect (which may be combined with any other aspects or features described herein), there may be considered a method for manufacturing a holographic optical element for use in a holographic reticle device. The method comprises: splitting a coherent beam of laser light into a reference beam and an object beam; directing the reference beam to a first side of a planar photosensitive material; and directing the object beam to a collimator, such that an output surface of the collimator redirects the object beam to a second side of the planar photosensitive material, opposite the first side, so as to record a hologram on the photosensitive material. A normal to the planar photosensitive material is tilted with respect to a normal to a centre of the output surface of the collimator, for example as discussed above with reference to the holographic optical system. The method of manufacturing may be extended to include one or more steps for providing and/or configuring any other elements of the holographic optical system as herein disclosed, for instance to result in a method of manufacturing a holographic optical system accordingly.

The method of manufacturing may result in use of the planar photosensitive material as an aberration-compensating holographic optical element in a holographic optical system as herein disclosed. The collimator used in the manufacture need not be the same as the collimator used in the holographic optical system (for replay), but if the collimators are different, they should have same focal lengths.

More specific details of a preferred embodiment will now be presented, particularly focusing on a modelled or simulated implementation of a design in accordance with the disclosure.

Referring next to FIG. 6, there is illustrated a schematic ray tracing model of an optical system in accordance with the embodiment of FIG. 4. This has been generated using ray tracing software sold by Zemax, LLC. This model comprises: point light source 601; chief ray 602; a marginal ray 603; spherical mirror 604; aberration correction HOE 605; a linear grating HOE 606; beamsplitter 607; an image presented to the eye 608. Although a scale is shown for the model, it is not intended that the specific dimensions be anything other than illustrative examples.

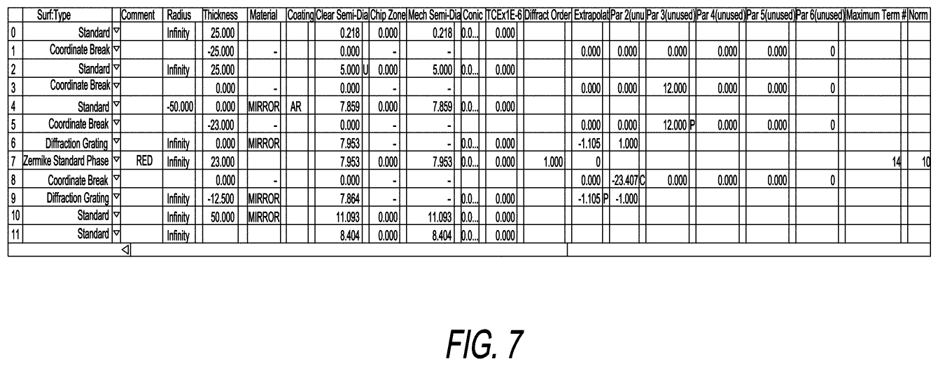

Reference is now made to FIG. 7, in which there is shown a first portion of lens data from ray tracing software, including distances and angles for the embodiment of FIG. 6. The optical surfaces are listed in the rows and their parameters provided along the columns.

In this model, the system has been optimised for collimation. As known to those skilled in the art, the lens data editor values can be altered without changing the result. More important variables may include the focal length of the spherical mirror 604 (focal length=25 mm, radius of curvature=50 mm, shown in surface 4), the tilt of the spherical mirror 604 (12 degrees in co-ordinate break surface 5) and the line spacing of the diffraction gratings of HOE 605 and HOE 606 (1105 lines/mm, surface 6=1.105). The aberration correction HOE (grating element) 605 is modelled as a combination of a diffraction grating (surface 6) and a Zernike standard phase surface (surface 7), although it is practically one element.

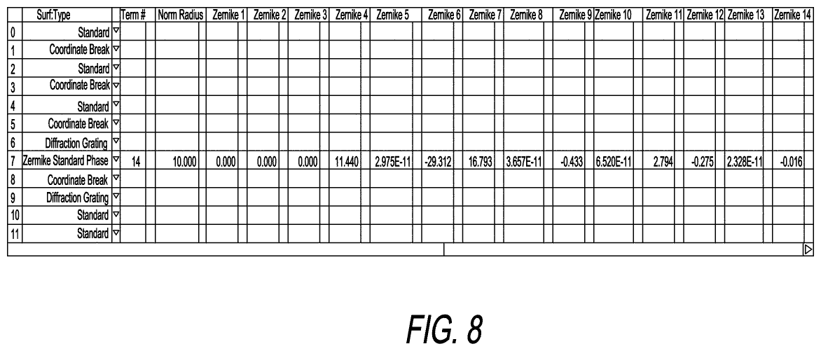

Referring now to FIG. 8, there is shown a second portion of lens data from ray tracing software, particularly for a Zernike phase surface (surface 7) of the HOE 605 in the embodiment of FIG. 6. This phase surface ideally corrects the incident pseudo-collimated aberrated wave to a perfectly collimated wave. Here it is an optically fabricated HOE, but it could be a computer generated and lithographically produced DOE (diffractive optical element). A phase surface can be described by the polynomial terms in the Zernike function; increased terms results in greater accuracy, but typically 14 terms (as used here) are sufficient. The Zernike value is the sum of all the Zernike terms and gives the root mean squared (RMS) wavefront error of the wave compared to the desired perfectly collimated wave. Ideally, this would be zero.

The values are: Zernike 1=0 (piston, a constant term), Zernike 2 and 3=0 (pure tilt terms), Zernike 4, 5, 6=11.44, 2.975E−11, −29.312 (spherical and cylindrical defocus terms), Zernike 7, 8, 9, 10=16.793, 3.657E−11, −0.433, 6.52E−11 (off-axis aberrations; coma, trefoil, astigmatism terms), Zernike 11, 12, 13, 14=2.794, −0.275, 2.328E−11, −0.016 (higher order terms to increase accuracy). The off-axis aberration terms 7, 8, 9, 10 may be difficult or impossible to fully correct with standard refractive optics and may require diffractive surfaces for full wavefront correction.

Although a specific embodiment has now been described, the skilled person will appreciate that various modifications and alternations are possible. It is of course to be understood that variations on the design distances, angles and component sizes are possible without changing the underlying disclosure. Also, further optical components can be incorporated to redirect and/or process the light as desired.

Changes to the light source 401 are possible. When using a light with a pinhole, the pinhole could be positioned behind the HOE 404 rather than to the side. This would reduce coma aberrations, but is less desirable, as the light will pass through extra optical elements, the device would be less compact, and HOE 404 could not be black-backed thus stray light would increase. Indeed, other positions for the light source could also be considered, but again having similar disadvantages. Where the pinhole is positioned behind the compensating HOE in replay, recording of the HOE may be achieved in a number of different ways. A first option may use the same arrangement for recording as replay. Alternatively, the object beam pinhole mask may be placed on the other side of the photosensitive material than in replay. Then, a collimating lens with the same focal length as the collimating mirror used for replay may be placed between the pinhole mask and the photosensitive material. Neither of these is ideal. The former option records an unwanted transmission hologram in the photosensitive material as well as the wanted hologram for compensation. The latter option may not perfectly compensate for aberrations.

The spherical mirror 403 could be replaced by an equivalent collimating lens (or a combination could be used to have the same effect). As noted above, a spherical mirror is considered more advantageous, but the equivalent lens would also introduce aberrations, including chromatic aberrations with a broadband source (for example, an LED).

The collimator (whether a spherical mirror or otherwise) need not be tilted with respect to the planar diffractive compensating surface. For example, the light source could be placed behind a transparent compensating element such that the light passes through it, onto the collimating mirror which is normal (head-on) relative to the compensating element. In general terms, this may be considered as the aberration-compensating holographic optical element being positioned between the light source and the collimator. However, this configuration should be less compact than the preferred embodiment and could create unwanted reflections and aberrations. Additionally or alternatively, the collimator, particularly in the form of a spherical mirror, could be parallel to the compensating element and the light source could be off axis relative to the collimator (that is, not along a central normal of the collimator output surface). Then, light from the light source may be reflected by the collimating mirror to the compensating HOE, which then directs light (by diffraction) back along a similar or the same direction. In general terms, the aberration-compensating holographic optical element may be positioned parallel to the collimator. Nevertheless, such an arrangement would result in a less compact form factor, as the optical path would be longer and the components more widely separated.

The reticle need not be a dot and/or a different type of light source may be used. One alternative is to use extended source such as a physical reticle, for example a crosshair created by a mask placed over an LED. This could be rotated to allow for different reticles to be used. A self-emissive micro-display (OLED/microLED) could be used to generate a dynamic (changing) reticle image, or an image could be projected onto the back of a transmissive diffuser from a micro-display, for instance a Liquid Crystal on Silicon (LCOS) or Digital Light Processing (DLP) micro-display.

The second HOE 405 could be omitted in some embodiments, although this would result in increased chromatic dispersion and therefore poorer output quality. As noted above, the second HOE 405 need not be fabricated holographically and may simply be a DOE, for example lithographically produced. Other fabrication techniques for all of the elements described may be considered, apart from those expressly discussed (for example, using digital rather than analogue methods, for instance a computer generated hologram from a digital display or a hologram built up pixel by pixel). Such other techniques often have limitations though and are generally not used.

The first HOE and/or second HOE need not be reflective and one or (more typically) both may be transmissive, or other elements may be transmissive. This would typically make the system larger and also may not allow black-backing of the surfaces to reduce stray light. However, some gunsights do use transmission elements backed onto a mirror, so they behave somewhat similarly to reflection holograms. Transmissive and reflective elements typically have different number of lines per unit distance, which can make design more difficult.

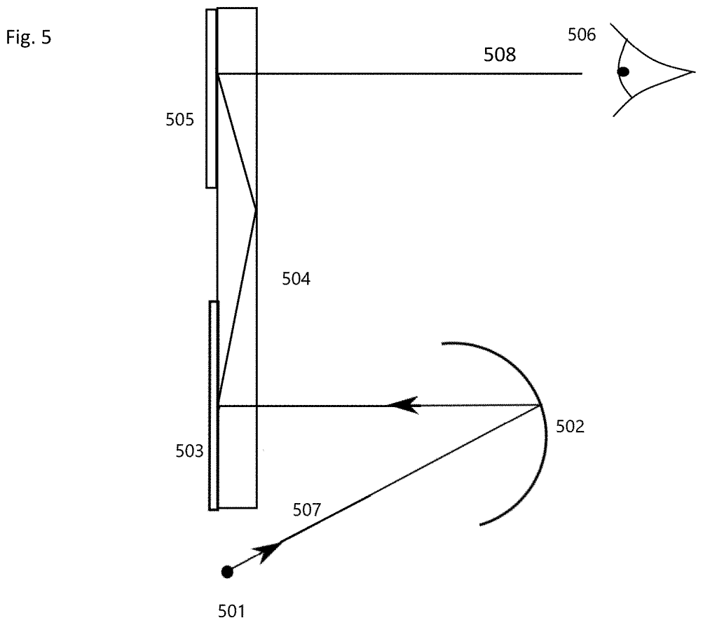

Reference is now made to FIG. 5, in which there is depicted a schematic diagram of an optical system for providing a red dot virtual image to a user in accordance with a second embodiment of the disclosure. This comprises: a light source 501; a spherical mirror 502; a waveguide 504; a holographic optical element (HOE) 503; and a diffraction grating 505. Reticle light is provided to a user eye 506. An axis of light 508 entering the user eye 506, comprising the reticle light and light passing through the waveguide 504 and the diffraction grating 505 from outside the optical system is shown.

Most of the elements of FIG. 4 are the same in FIG. 5, except the two diffraction gratings (of the HOE 503 and diffraction grating 505, respectively) are coupled via the waveguide 504 (a planar glass and/or plastic substrate, which may also be termed a lightguide) rather than via free space. The light source 501 is a point source with an emitted chief ray 507 incident on the spherical mirror 502. As in FIG. 4, the spherical mirror 502 is a tilted with reference to the HOE 503. In other words, the angle between a normal to a centre of the reflective surface of the spherical mirror 502 and a normal to the HOE 503 is non-zero (that is, the normals are not parallel). All parameters discussed above with reference to FIG. 4, including the possible value for the angle between the normals are also applicable to this embodiment.

The HOE 503 provides an incoupling holographic grating with aberration correction (in the same manner as HOE 404 with reference to FIG. 4). Diffraction grating 505 is an outcoupling linear diffraction grating (in the same manner as HOE 405 with reference to FIG. 4). The HOE 405 (which could alternatively be a DOE as suggested above) is also configured, together with the HOE 503 to provide zero chromatic dispersion. The outcoupled light, including a chief outcoupled ray 508, provides a virtual image that presented to the eye 506.

In this case, the HOE 503 and the diffraction grating 505 are reflective. However, they could instead be transmissive, but in this case, they would typically be placed on the opposite side of the waveguide 504 from that shown in FIG. 5. Unlike the embodiment of FIG. 4, the use of transmissive diffractive elements (the HOE 503 and/or the diffraction grating 505) would not necessarily degrade the overall performance and/or difficulty of design in the design of FIG. 5.

As with reference to FIG. 4, the HOE 503 and the diffraction grating 505 are made holographically. Whereas in the embodiment of FIG. 4, the reference beam angle is designed to diffract the light towards the next optical element, in FIG. 5, the reference beam angle is designed to diffract the light at an angle greater than total internal reflection within the waveguide 504.

A potential benefit of the design shown in FIG. 5 is that it could be made more compact than the design of FIG. 4. In addition, the monolithic nature of the design of FIG. 5 may help in a gunsight (as the incoupler and outcoupler elements may be held rigidly with respect to each other, which may help to prevent misalignment when there is recoil).

Returning to the general aspects of the disclosure further discussed above, there may additionally be considered a waveguide, configured to convey light from the aberration-compensating holographic optical element to the chromatic-compensating optical element. Advantageously, the aberration-compensating holographic optical element is then configured to couple light from the collimator into the waveguide. Beneficially, the chromatic-compensating optical element is configured to couple light out from the waveguide. The waveguide may interpose between the collimator and the aberration-compensating holographic optical element and/or between the chromatic-compensating optical element and a position configured for viewing.

Various modifications and alternations are possible in respect of this second embodiment, including those discussed above with reference to earlier descriptions.

What is claimed is:

1. A holographic optical system, comprising:
a light source;
a collimator arranged to receive light from the light source;
wherein the collimator has an output surface configured to provide collimated light, and optical properties of the collimator generate aberrations in the collimated light; and
an aberration-compensating holographic optical element having a planar diffractive surface is arranged to receive collimated light from the output surface;
wherein the planar diffractive surface has optical properties so that output light from the planar diffractive surface is compensated for the aberrations generated by the collimator.

2. The holographic optical system of claim 1, wherein the optical properties of the collimator generate spherical and/or coma aberrations in the collimated light; and wherein the planar diffractive surface has optical properties so that output light from the planar diffractive surface is compensated for the spherical and/or coma aberrations generated by the collimator.

3. The holographic optical system of claim 1, further comprising:
a reticle-generating holographic optical element, having a reticle image holographically recorded into it.

4. The holographic optical system of claim 1, wherein the collimator has a focal length and a distance between the light source and the collimator is less than the focal length.

5. The holographic optical system of claim 1, further comprising:
an optical combining element, arranged to receive the output light and to receive light from outside the optical system and to combine the received light, and to direct the combined light along an axis; and
wherein the collimator is off-axis.

6. The holographic optical system of claim 1, further comprising:
a chromatic-compensating optical element having a diffractive surface; and
wherein the planar diffractive surface of the aberration-compensating holographic optical element and the diffractive surface or the chromatic-compensating optical element are together configured to provide zero chromatic dispersion.

7. The holographic optical system of claim 6, wherein the planar diffractive surface of the aberration-compensating holographic optical element and the diffractive surface of the chromatic-compensating optical element are parallel.

8. The holographic optical system of claim 6, wherein the chromatic-compensating optical element is a holographic optical element.

9. The holographic optical system of claim 8, further comprising:
a reticle-generating holographic optical element, having a reticle image holographically recorded into it; and
wherein the chromatic-compensating optical element is the reticle-generating holographic optical element.

10. The holographic optical system of claim 6, wherein the aberration-compensating holographic optical element and the chromatic-compensating optical element are reflective.

11. The holographic optical system of claim 6, further comprising:
a waveguide configured to convey light from the aberration-compensating holographic optical element to the chromatic-compensating optical element.

12. The holographic optical system of claim 11, wherein the aberration-compensating holographic optical element is configured to couple light from the collimator into the waveguide; and
wherein the chromatic-compensating optical element is configured to couple light out from the waveguide.

13. The holographic optical system of claim 12, wherein the waveguide is between the collimator and the aberration-compensating holographic optical element.

14. The holographic optical system of claim 1, wherein the planar diffractive surface has a normal that is tilted with respect to a normal to a centre of the output surface of the collimator; or the aberration-compensating holographic optical element is positioned between the light source and the collimator; or the aberration-compensating holographic optical element is parallel to the collimator.

15. The holographic optical system of claim 1, wherein the collimator is a spherical mirror and the output surface is a concave surface.

16. The holographic optical system of claim 1, wherein the light source comprises at least one light source selected from the group consisting of: a point light source, a LED, a laser diode, a vertical-cavity surface-emitting laser (VCSEL) device, an arrangement comprising a light source and a mask, a self-emissive display, and a display projected onto a transmissive diffuser.

17. The holographic optical system of claim 1, further comprising:
a brightness controller, configured to adjust an electrical current applied to the light source, in order to control brightness of the output light.

18. A gunsight comprising the holographic optical system of claim 1.

19. A method for manufacturing a holographic optical element for use in a holographic reticle device, comprising the steps of:
splitting a coherent beam of laser light into a reference beam and an object beam;
directing the reference beam to a first side of a planar photosensitive material;
directing the object beam to a collimator, so that an output surface of the collimator redirects the object beam to a second side of the planar photosensitive material, opposite the first side, to record a hologram on the photosensitive material; and
wherein the planar photosensitive material has a normal that is tilted with respect to a normal to a centre of the output surface of the collimator.

20. The method of claim 19, further comprising the step of:
using the planar photosensitive material as the aberration-compensating holographic optical element in a holographic optical system.

21. The method of claim 20, wherein the collimator in the step of directing the object beam to the photosensitive material has a same focal length as a collimator in the holographic optical system.
